(19) United States
(12) Patent Application Publication
(10) Pub. No.: US 2011/0076387 A1
(43) Pub. Date: Mar. 31, 2011

(54) METHOD FOR IMPARTING ANTIBIOTIC ACTIVITY TO THE SURFACE OF A SOLID SUBSTRATE

(75) Inventors: David Joseph Koehl, Bethlehem, PA (US); Joseph Kimler, Yardville, NJ (US); Larry Kent Hall, Easton, PA (US); Philip Gerdon Sweeny, Hackettstown, NJ (US)

(73) Assignee: LONZA, INC., Allendale, NJ (US)

(21) Appl. No.: 12/569,564

(22) Filed: Sep. 29, 2009

(51) Int. Cl. B05D 3/02; B05D 3/06

(52) U.S. Cl. 427/2.31; 427/385.5; 427/536; 427/389.9

(57) ABSTRACT

The present invention relates to a method for imparting antibiotic activity to a surface of a solid substrate by exposing a solid substrate composition to conditions suitable for covalent grafting and thermal polymerization of the substrate.

### BACKGROUND OF THE INVENTION

Quaternary ammonium salts (quats) are well known for their antimicrobial activity and/or antiseptic activity. As a result, quaternary ammonium groups have been incorporated into various chemical structures. For example, U.S. Pat. No. 6,251,967 to Perichaud, et al. disclose a method for making a non-cross-linked polymer from monomers containing a quaternary ammonium group.

There is also a great deal of interest in finding effective and efficient ways of attaching compounds containing quaternary ammonium groups onto solid substrates. U.S. Patent Application No. 2005/0095266 to Perichaud, et al. discloses a method for treating the surface of a solid substrate involving photopolymerization and covalent grafting of monomers containing an antibiotic group to a solid substrate using photoprimers and grafting agents. The photopolymerization and covalent grafting occurs upon exposure of the solid substrate and a formulation containing the monomers to ultraviolet radiation.

However, the use of ultraviolet radiation has its limitations. For instance, ultraviolet radiation only penetrates a portion of a solid substrate, e.g., a fabric, resulting in only the surface of the fabric being coated with the antibiotic polymer.

There remains a need for attaching an antibiotic polymer to a solid substrate so that the solid substrate will have layers of antimicrobial and/or antiseptic activity.

### SUMMARY OF THE INVENTION

The present invention relates to a method for imparting antibiotic activity to a surface of a solid substrate, comprising:

a) contacting the solid substrate with a composition comprising one or more antibiotic monomers QⱼX^{j} wherein:

Q represents a quaternary ammonium ion having formula (I):

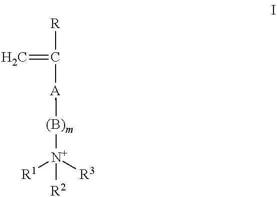

wherein:
A represents

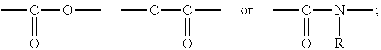

R independently represents H or CH₃;
B represents a linear or branched C₁-C₅ alkanediyl chain; or an arylene or arylalkanediyl group;
m represents 0 or 1;
R¹ and R² independently represent a C₁-C₅ alkyl group;
R³ represents a C₈-C₂₀ alkyl group, an aryl group, or an arylalkyl group; and
X⁻ represents an anion having valence j;
   to form a solid substrate composition; and
   b) exposing the solid substrate composition to conditions suitable for covalent grafting and thermal polymerization of the substrate.

In a preferred embodiment, the solid substrate further comprises:
i) one or more monomers or oligomers selected from the group consisting of acrylate, epoxide, and vinyl ether monomers or oligomers suitable for copolymerization with the antibiotic monomer; and
ii) one or more radical initiators suitable for thermal polymerization.
   The solid substrate composition may also preferably comprise iii) one or more grafting agents.

For a better understanding of the present invention, together with other and further advantages, reference is made to the following detailed description, and its scope will be pointed out in the claims.

### DETAILED DESCRIPTION

The invention relates to a method for imparting antibiotic activity to a solid surface. Antibiotic activity includes any antimicrobial or antiseptic activity, e.g., antibacterial activity, anti-fungal activity, and anti-yeast activity. Antibiotic activity includes activity that either stops or slows the growth of, or kills, a microbe, e.g., biocidal or biostatic activity.

The solid substrate can be any solid, porous or non-porous material. Examples of solid substrates include, but are not limited to, non-woven or woven textiles made from synthetic or natural fibers or threads, cleaning wipes, plastic, medical gauze or bandages, water filtration media, ceramic, glass, diatomaceous earth, sand, filter cartridges, diapers, medical or surgical masks, clothing, sponges, brushes, cellulose, wood, surfaces of pharmaceutical clean rooms, and bathroom surfaces such as walls, ceilings, floors, doors, flush handles, and toilet seats.

The method involves: a) contacting the solid substrate with a composition comprising one or more monomers QⱼX^{j} wherein Q represents a quaternary ammonium ion having formula (I) to form a solid substrate composition and b) exposing the solid substrate composition to conditions suitable for covalent grafting and thermal polymerization of the substrate. Suitable conditions for covalent grafting and thermal polymerization include, but are not limited to, the use of an initiator and the pre-treating of the substrate either with a corona treatment or plasma discharge treatment. Corona treatments and plasma discharge treatments may impart better grafting.

The solid substrate is contacted with the monomer composition by any means possible. Some examples of contacting the solid substrate with the monomer composition include introducing the solid substrate into a solution of the monomer composition or spraying the monomer composition onto the solid substrate.

The quaternary ammonium ion of formula (I) is show below:

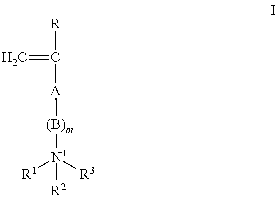

In formula (I) A represents:

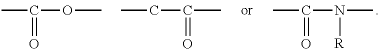

In the three possible structures for A shown above, the left side of the structure as shown is attached to the vinyl group (H₂C═CR—) and the right side of the structure as shown is attached to B. Therefore, the three possibilities for A in formula (I) are shown below:

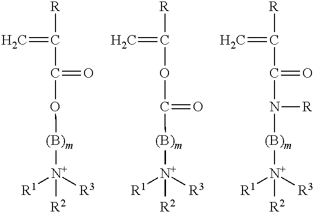

In formula (I), R independently represents H or CH₃.

In —(B)ₘ—, m represents 0 or 1. B represents a linear or branched C₁-C₅ alkanediyl chain; or an arylenyl or arylenylalkanedienyl group. A linear C₁-C₅ alkanediyl chain may be represented as —(CH₂)ₙ—, where n=1 to 5. Therefore, an alkanediyl chain is bonded independently at each end to another chemical moiety, e.g., to a group, or to an atom. In a preferred embodiment, m is 1 and B represents at least a linear C₂ alkanediyl chain so that at least two carbon atoms separate A from the nitrogen of the ammonium ion.

Examples of branched C₁-C₅ alkanediyl chains are shown below:

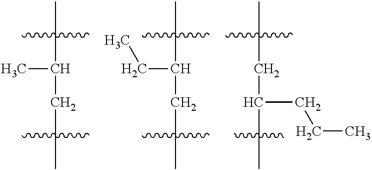

When m is 0, group A is directly connected to the nitrogen of the quaternary ammonium group. Preferably, the letter m is 1.

Arylenyl groups are aromatic groups bonded independently to two chemical moieties, e.g., to a group, or to an atom, and may be represented as —Ar— wherein Ar is phenylene or heterocycloarylenyl groups

The arylenyl groups may be bonded the two chemical moieties at any two positions of the aromatic ring. For example, possible phenylene groups are shown below:

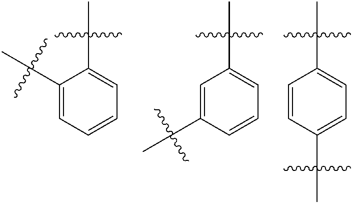

Heterocyclic arylenyl groups contain rings with 5-6 ring members having one to three heteroatoms selected from —O—, —S—, ═N—, or NR⁴, wherein R⁴ represents hydrogen, methyl, or ethyl. Examples of heterocyclic arylenyl groups include thiophenylene, furylene, pyrrolylene, pyrazinylene, pyrimidinylene, imidazolylene, oxazolylene, and pyrimidinylene. For example, possible heterocyclic arylenyl groups are shown below:

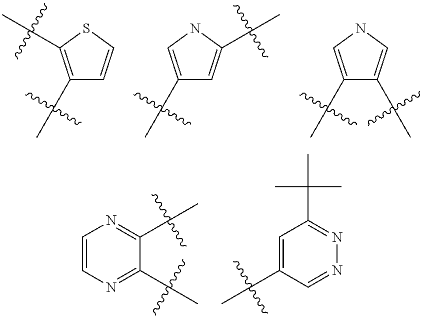

Arylenylalkanediyl groups contain any of the arylenyl groups described above bonded to any of any of the alkanediyl groups described above, and may be in either direction, e.g., —Ar—(CH₂)ₙ— or —(CH₂)ₙ—Ar—. Examples of arylenylalkanediyl groups are shown below:

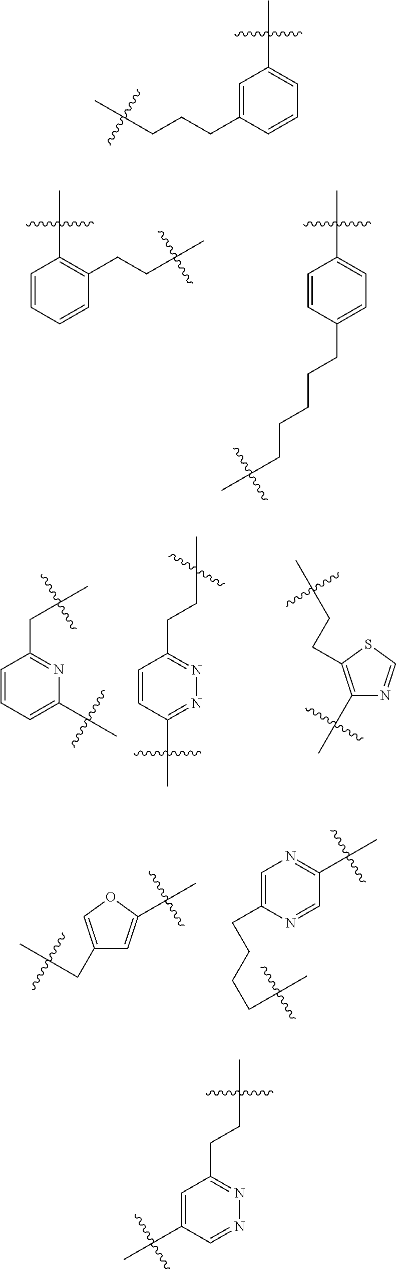

R¹ and R² independently represent a saturated and linear or branched C₁-C₅ alkyl group. Examples of C₁-C₅ alkyl groups include methyl, ethyl, propyl, isopropyl, butyl, isobutyl, t-butyl, and pentyl.

R³ represents a C₈-C₂₀ hydrocarbyl group, an aryl group, a hydrocarbylaryl group, or an aryhydrocarbyl group. The hydrocarbyl groups are saturated (alkyl) or unsaturated (alkenyl). Examples of saturated C₈-C₂₀ alkyl groups include octyl, decyl, dodecyl, tridecyl, and icosanyl. Examples of unsaturated C₈-C₂₀ alkenyl groups include 5-octenyl, oleyl, linoleyl, linolenyl, and elaidolinolenyl.

Aryl groups may be carbocyclic or heterocyclic. A carbocyclic aryl group is phenyl. Heterocyclic aryl groups contain rings with 5-6 ring members having one to three heteroatoms selected from —O—, —S—, ═N—, or NR⁴, wherein R⁴ represents hydrogen, methyl, or ethyl. Examples of heterocyclic aryl groups include thiophenyl, furyl, pyrrolyl, pyrazinyl, pyrimidinyl, imidazolyl, oxazolyl, and pyrimidinyl.

Hydrocarbylaryl and aryhydrocarbyl groups contain an aryl or arylenyl group bonded to a saturated, branched or linear C₁-C₅ alkyl chain or group. Examples of arylhydrocarbyl groups are shown below:

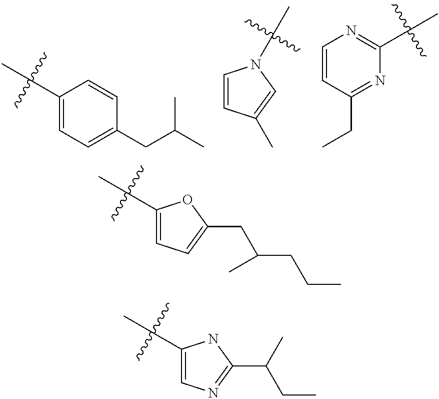

Examples of hydrocarbylaryl groups are shown below:

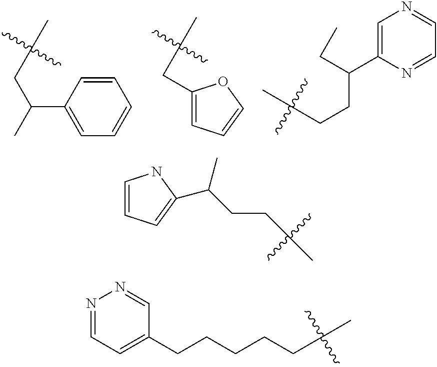

X represents an anion having valence j. Examples of anions include halogen, sulphate, phosphate, nitrate, cyano, or organic anions such as tosylate, salicylate, benzoate, acetate, or undecylenate. The letter j may represent, for example, 1, 2, or 3. The anion X⁻ is preferably a halide, i.e., Cl⁻, Br⁻, F⁻, or I⁻, wherein j is 1.

In a preferred embodiment, the monomer QX is:

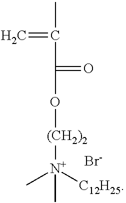

The solid substrate composition may further comprise i) one or more monomers or oligomers selected from the group consisting of acrylate, epoxide, and vinyl ether monomers or oligomers suitable for copolymerization with the antibiotic monomer; and ii) one or more radical initiators suitable for thermal polymerization.

An oligomer is comprised of two or more monomers. The maximum number of monomers contemplated for the oligomers of the invention is eight.

Acrylate, epoxide, and vinyl ether monomers or oligomers suitable for copolymerization with the antibiotic monomer are well-known in the art. For example, U.S. Patent Publication No. 2005/0095266 (U.S. Ser. No. 10/496,792) to Perichaud, et al. discloses examples of suitable acrylate, epoxide, and vinyl ether monomers and oligomers in paragraphs 137-152, relevant portions of which are incorporated herein by reference. Preferred acrylate monomers include 1,6 hexanediol diacrylate and bis-phenol A ethoxy diacrylate.

Radical initiators suitable for thermal polymerization are well-known in the art. Examples of suitable radical initiators include tert-amyl peroxybenzoate; 4,4-azobis(4-cyanovaleric acid); 2,2′-azobisisobutyronitrile; benzoyl peroxide; 2,2-bis(tert-butylperoxy)butane; 1,1-bis(tert-butylperoxy)cyclohexane; 2,5-bis(tert-butylperoxy)-2,5-dimethylhexane; 2,5-bis(tert-butylperoxy)-2,5-dimethyl-3-hexyne; bis(1-(tert-butylperoxy)-methylethyl)benzene; 1,1-bis(tert-butylperoxy)-3,3,5-trimethylcyclohexane; tert-butyl hydroperoxide; tert-butyl peracetate; tert-butyl peroxide; tert-butyl peroxybenzoate; tert-butylperoxy isopropyl carbonate; cumene hydroperoxide; cyclohexanone peroxide; dicumyl peroxide; lauroyl peroxide; 2,4-pentanedione peroxide; peracetic acid; and potassium persulfate. Preferably, the radical initiator is benzoyl peroxide.

The solid substrate composition may further comprise iii) one or more grafting agents and optionally be pretreated with a corona treatment or plasma discharge treatment in order to impart better grafting. Grafting agents are well-known in the art. For example, grafting agents are described in U.S. Patent Publication No. 2005/0095266 (U.S. Ser. No. 10/496,792) to Perichaud, et al. in paragraphs 99-132.

The solid substrate composition is exposed to conditions suitable for covalent grafting and thermal polymerization of the substrate. Such conditions are well known to a person having ordinary skill in the art. For example, a convenient minimum temperature for thermal polymerization is at least about 60° C., more preferably at least about 80° C. A convenient maximum temperature for thermal polymerization is at most about 150° C., more preferably at most about 130° C. Furthermore, the solid substrate composition may be exposed to conditions suitable for covalent grafting and thermal polymerization for a least about 5 minutes and at most about 30 minutes.

The compounds QX can be synthesized by methods well known in the art. For example, U.S. Pat. No. 6,251,967 to Perichaud et al., discusses the synthesis of quaternary ammonium salts at cols. 5-10, which is incorporated herein by reference.

In this specification, groups of various parameters containing multiple members are described. Within a group of parameters, each member may be combined with any one or more of the other members to make additional sub-groups. For example, if the members of a group are a, b, c, d, and e, additional sub-groups specifically contemplated include any two, three, or four of the members, e.g., a and c; a, d, and e; b, c, d, and e; etc.

In some cases, the members of a first group of parameters, e.g., a, b, c, d, and e, may be combined with the members of a second group of parameters, e.g., A, B, C, D, and E. Any member of the first group or of a sub-group thereof may be combined with any member of the second group or of a sub-group thereof to form additional groups, i.e., b with C; a and c with B, D, and E, etc.

For example, in the present invention, groups of various parameters are defined (e.g. Q, A, R, B, R¹, R², R³, and X). Each group contains multiple members. For example, R³ represents a C₈-C₂₀ alkyl group, an aryl group, or an arylalkyl group. Each member may be combined with each other member to form additional sub-groups, e.g., C₈-C₂₀ alkyl group and aryl group, aryl group and arylalkyl group, and C₈-C₂₀ alkyl group and arylalkyl group.

The instant invention further contemplates embodiments in which each element listed under one group may be combined with each and every element listed under any other group. For example, R¹ and R² are identified above as independently representing a C₁-C₅ alkyl group. R³ is identified above as independently representing a C₈-C₂₀ alkyl group, an aryl group, or an arylalkyl group. Each element of R¹ and R² (a C₁-C₅ alkyl group) can be combined with each and every element of R³ (a C₈-C₂₀ alkyl group, an aryl group, or an arylalkyl group). For example, in one embodiment, R′ may be a propyl group; R² may be a pentyl group; and R³ may be an aryl group. Alternatively, R′ may a methyl group; R² may be an ethyl group; and R³ may be an arylalkyl group. Similarly, a third group is B, in which the elements are defined as a linear or branched C₁-C₅ alkanediyl chain; or an arylene or arylalkanediyl group. Each of the above embodiments may be combined with each and every element of B. For example, in the embodiment wherein R¹ is a butyl group; R² is a methyl group; R³ is an octyl group; and B may be an arylene group (or any other chemical moiety within the element of B).

With each group, it is specifically contemplated that any one of more members can be excluded. For example, if radical initiators are defined as tert-amyl peroxybenzoate; 4,4-azobis(4-cyanovaleric acid); 2,2′-azobisisobutyronitrile; benzoyl peroxide; 2,2-bis(tert-butylperoxy)butane; 1,1-bis(tert-butylperoxy)cyclohexane; 2,5-bis(tert-butylperoxy)-2,5-dimethylhexane; 2,5-bis(tert-butylperoxy)-2,5-dimethyl-3-hexyne; bis(1-(tert-butylperoxy)-methylethyl)benzene; 1,1-bis(tert-butylperoxy)-3,3,5-trimethylcyclohexane; tert-butyl hydroperoxide; tert-butyl peracetate; tert-butyl peroxide; tert-butyl peroxybenzoate; tert-butylperoxy isopropyl carbonate; cumene hydroperoxide; cyclohexanone peroxide; dicumyl peroxide; lauroyl peroxide; 2,4-pentanedione peroxide; peracetic acid; and potassium persulfate; it is also contemplated that radical initiators are defined as tert-amyl peroxybenzoate; tert-butyl hydroperoxide; and lauroyl peroxide.

The compounds of this invention are limited to those that are chemically feasible and stable. Therefore, a combination of substituents or variables in the compounds described above is permissible only if such a combination results in a stable or chemically feasible compound. A stable compound or chemically feasible compound is one in which the chemical structure is not substantially altered when kept at a temperature of 40° C. or less, in the absence of moisture or other chemically reactive conditions, for at least a week.

A list following the word “comprising” is inclusive or open-ended, i.e., the list may or may not include additional unrecited elements. A list following the words “consisting of” is exclusive or closed ended, i.e., the list excludes any element not specified in the list.

### EXAMPLES

### Example 1

The synthesis of the antimicrobial monomer M1 is as follows:

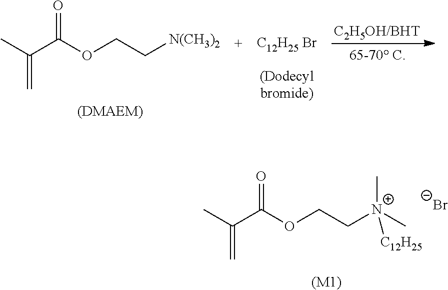

A 1% aqueous solution of the Monomer M1 is made by dissolving 5 g of monomer M1—into 494.25 g of D.I. water. In a separate beaker, a mixture containing 9.9 g of 1,6, hexanediol diacrylate and 0.1 g of benzyl peroxide is sonicated for 10 minutes in order to dissolve the benzyl peroxide. Once the benzyl peroxide is dissolved, 0.75 g of this mixture is added to the 1% Monomer M1 solution and mixed (using a magnetic stir bar). The solution is hazy at this point. While continuing to mix, a plastic pipette is used to extract some of the liquid. The liquid in the pipette is then transferred to a dry wipe substrate. The amount added is such as to deliver a 3% concentration of Monomer M1 to the wipe substrate. For example, a dry wipe weighs approximately 2 grams. By adding 6 grams of the Monomer M1 solution to the wipe, 3% by weight of Monomer M1 is added to the wipe.

Once the liquid is added to the wipe substrate, it must be heated to at least 80° C. and dried completely. An oven set at 80° C. was used to dry the substrate.

The prepared samples were then evaluated using the American Association of Textile Chemists and Colorists test method AATCC 100-2004. A mixed bacteria culture was used.

Bacterial Counts (CFU/gram)

| Sample # | Test Samples | Day 0 | 24 Hrs | Day 7 |
|---|---|---|---|---|
| 1 | Monomer M1 on Wipes | 4.7 × 10⁶ | 1.0 × 10³ | <100 |
| 2 | Untreated Control Wipes | 5.1 × 10⁶ | 1.3 × 10⁷ | 1.5 × 10⁸ |
| | Bacterial Inoculum | 7.0 × 10⁶ | | |

### Example 2

The antimicrobial monomer M1-C12 can then be converted into a polymer either via UV curing or thermal techniques. The antimicrobial activity of the monomer is maintained even after polymerization. M1-C12 is only one of many monomers that can be made having antimicrobial properties. See Appendix A for list of other examples of monomers that can be used.

The polymerization and grafting of the monomers can be achieved either through UV or thermal techniques. For this application (applied to either medical gauze or bandages), the preferred technique is by thermal polymerization and grafting. This is because it is desirable to have the polymer grafted throughout the substrate. UV techniques would only produce grafted polymer on the surface of the substrate. UV techniques are more desirable for solid surfaces where a coating of the surface is only needed.

In the study described below, benzyl peroxide was used as the initiator for polymerizing and grafting the monomer to the medical gauze or bandage. Benzyl peroxide is not soluble in Monomer M1-C12, so 1,6 hexanediol diacrylate (Miramer M200) was used as a co-monomer to solubilize the benzyl peroxide. A 1% benzyl peroxide in 1,6 hexanediol diacrylate was made. The Monomer M1-C12 (0.8 grams) was dissolved in D.I. water (199.1 grams). To this mixture, 0.1 grams of the 1% benzyl peroxide in 1,6 hexanediol diacrylate was added.

A total of 2.5 grams of the above described mixture was absorbed onto a piece of medical gauze (Johnson & Johnson's FirstAid® brand) weighing 0.9 grams. The gauze was then dried in a microwave oven for 5 minutes in order to dry off the excess moisture and bring the temperature of the gauze to above 80° C. in order to initiate the polymerization reaction. A total of three samples were prepared using the same procedure. Samples of bandages (Johnson & Johnson's Band-Aid® brand) were prepared by absorbing 1.5 grams of the above described mixture onto a piece of bandage weighing 0.6 grams. The bandage was then dried in a microwave oven for 5 minutes in order to dry off the excess moisture and bring the temperature of the gauze to above 80° C. in order to initiate the polymerization reaction. A total of three samples were prepared using the same procedure.

Test method AATCC 100 was used to evaluate the antimicrobial properties of the treated medical gauze and bandages. The table below summarizes the performance against S. aureus.

Organism Counts (CPU)

| | | Time = | Log | % |
|---|---|---|---|---|
| Sample | Time = 0 | 24 Hours | Reduction | Reduction |
| Untreated Gauze | 3.0 × 10⁷ | 3.0 × 10⁸ | NA | NA |
| Treated Gauze | 2.7 × 10⁷ | 7.8 × 10³ | 4.59 | 99.997 |
| Untreated Band Aid | 3.0 × 10⁷ | 3.0 × 10⁸ | NA | NA |
| Treated Band Aids | 3.0 × 10⁷ | <100 | 6.48 | 99.999 |

### Example 3

The antimicrobial monomer M1-C12 can then be converted into a polymer either via UV curing or thermal techniques. The antimicrobial activity of the monomer is maintained even after polymerization. M1-C12 is only one of many monomers that can be made having antimicrobial properties. See Appendix A for list of other examples of monomers that can be used.

The polymerization and grafting of the monomers can be achieved either through UV or thermal techniques.

In the method described below, benzyl peroxide was used as the initiator for polymerizing and grafting the monomer to sand. Benzyl peroxide is not soluble in Monomer M1-C12, so 1,6 hexanediol diacrylate (Miramer M200) was used as a co-monomer to solubilize the benzyl peroxide. A 1% benzyl peroxide in 1,6 hexanediol diacrylate was made. The Monomer M1-C12 (0.8 grams) was dissolved in D.I. water (199.1 grams). To this mixture, 0.1 grams of the 1% benzyl peroxide in 1,6 hexanediol diacrylate was added.

A total of 20 grams of the above described mixture was absorbed onto 50 grams of sand (Kolor Scape White Play Sand). The sand was then dried in a microwave oven for 5 minutes in order to dry off the excess moisture and bring the temperature of the sand to above 80° C. in order to initiate the polymerization reaction. A total of two samples were prepared using the same procedure.

Since the antimicrobial polymer is cationic in nature, it will stain a blue color when exposed to a solution of bromophenol blue solution. The above described treated sand sample turned blue when exposed to a bromophenol blue solution and the blue color would not rinse off the sand when washed with water. Where as an untreated sand sample did not retain a blue color after washing with water. This experiment demonstrates that the antimicrobial polymer is grafted onto the sand particles.

### APPENDIX A

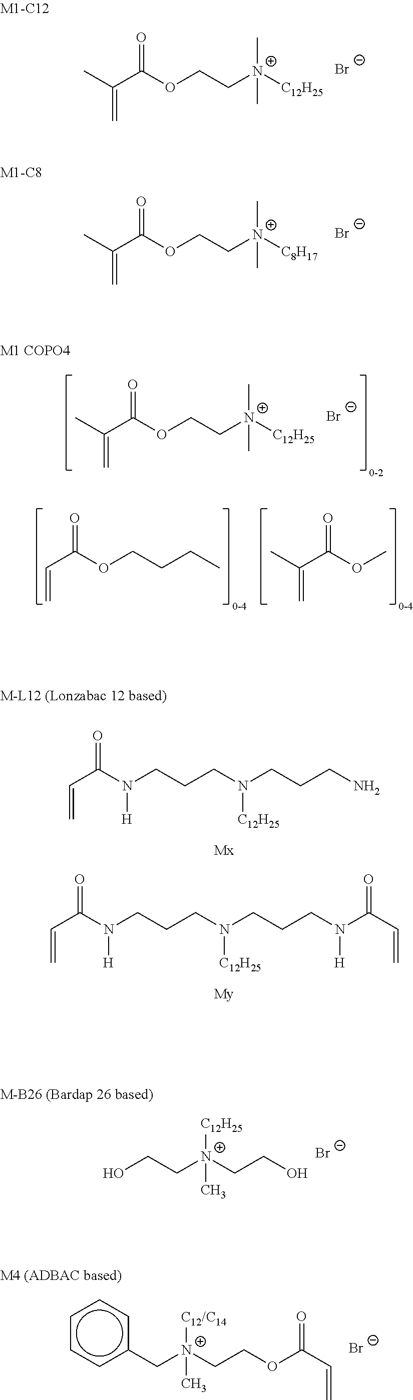

1. A method for imparting antibiotic activity to a surface of a solid substrate, comprising:
a) contacting the solid substrate with a composition comprising one or more antibiotic monomers QⱼX^{j} wherein:
Q represents a quaternary ammonium ion having formula (I): 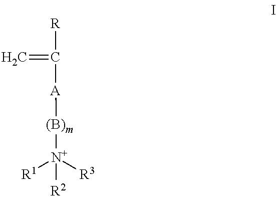
wherein:
A represents 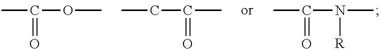
R independently represents H or CH₃;
B represents a linear or branched C₁-C₅ alkanediyl chain; or an arylene or arylalkanediyl group;
m represents 0 or 1;
R¹ and R² independently represent a C₁-C₅ alkyl group;
R³ represents a C₈-C₂₀ alkyl group, an aryl group, or an arylalkyl group; and
X⁻ represents an anion having valence j;
to form a solid substrate composition; and
b) exposing the solid substrate composition to conditions suitable for covalent grafting and thermal polymerization of the substrate.

2. A method according to claim 1, wherein the monomer comprises:

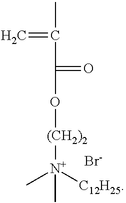

3. A method according to claim 1, wherein m is 1.

4. A method according to claim 3, wherein B is at least a linear C₂ alkanediyl chain.

5. A method according to claim 1, wherein the conditions in b) comprise a minimum temperature of about 60° C. and a maximum temperature of about 150° C.

6. A method according to claim 1, wherein the conditions in b) comprise a minimum temperature of about 80° C. and a maximum temperature of about 130° C.

7. A method according to claim 1, wherein the solid substrate composition in b) is exposed to the conditions for at least about 5 minutes.

8. A method according to claim 1, wherein the solid substrate composition in b) is exposed to the conditions for at most about 30 minutes.

9. A method according to claim 1, wherein X is a halide.

10. A method according to claim 1, wherein the solid substrate composition further comprises:
i) one or more monomers or oligomers selected from the group consisting of acrylate, epoxide, and vinyl ether monomers or oligomers suitable for copolymerization with the antibiotic monomer; and
ii) one or more radical initiators suitable for thermal polymerization.

11. A method according to claim 10, wherein the solid substrate composition further comprises iii) one or more grafting agents.

12. A method according to claim 11, wherein the solid substrate is pre-treated with a corona treatment or plasma discharge treatment.

13. A method according to claim 1, wherein the solid substrate is porous.

14. A method according to claim 1, wherein the solid substrate is a non-woven or woven textile.

15. A method according to claim 14, wherein the solid substrate is a non-woven textile and the non-woven textile is a cleaning wipe.

16. A method according to claim 1, wherein the solid substrate comprises a plastic.

17. A method according to claim 1, wherein the solid substrate is a medical gauze or bandage.

18. A method according to claim 1, wherein the solid substrate is a water filtration medium.

19. A method according to claim 18, wherein the water filtration medium comprises plastic, ceramic, glass, diatomaceous earth, or sand.

20. A method according to claim 18, wherein the water filtration medium comprises filter cartridges.

21. A method according to claim 1, wherein the solid substrate is a diaper.

22. A method according to claim 1, wherein the solid substrate is a medical or surgical mask.

23. A method according to claim 1, wherein the solid substrate comprises a surface used in a pharmaceutical clean room.

24. A method according to claim 1, wherein the solid substrate comprises a surface used in a bathroom.

25. A method according to claim 24, wherein the surface used in a bathroom is a wall, a ceiling, a floor, a door, a toilet seat, or a flush handle.

26. A method according to claim 10, wherein the one or more radical initiators are selected from the group consisting of tert-amyl peroxybenzoate; 4,4-azobis(4-cyanovaleric acid); 2,2′-azobisisobutyronitrile; benzoyl peroxide; 2,2-bis(tert-butylperoxy)butane; 1,1-bis(tert-butylperoxy)cyclohexane; 2,5-bis(tert-butylperoxy)-2,5-dimethylhexane; 2,5-bis(tert-butylperoxy)-2,5-dimethyl-3-hexyne; bis(1-(tert-butylperoxy)-methylethyl)benzene; 1,1-bis(tert-butylperoxy)-3,3,5-trimethylcyclohexane; tert-butyl hydroperoxide; tert-butyl peracetate; tert-butyl peroxide; tert-butyl peroxybenzoate; tert-butylperoxy isopropyl carbonate; cumene hydroperoxide; cyclohexanone peroxide; dicumyl peroxide; lauroyl peroxide; 2,4-pentanedione peroxide; peracetic acid; and potassium persulfate.

27. A method according to claim 26, wherein the one or more radical initiator is benzoyl peroxide.

28. A method according to claim 10, wherein the one or more monomers or oligomers are selected from the group consisting of 1,6 hexanediol diacrylate or bis-phenol A ethoxy diacrylate.
